(19) United States
(12) Patent Application Publication
(10) Pub. No.: US 2018/0138804 A1
(43) Pub. Date: May 17, 2018

(54) VOLTAGE SOURCE FOR MODULATED DC VOLTAGES

(71) Applicant: IIE GMBH & CO. KG, SOYEN (DE)

(72) Inventor: EKKEHARD KRESS, WASSERBURG (DE)

(21) Appl. No.: 15/574,556

(22) PCT Filed: Jun. 15, 2016
(86) PCT No.: PCT/EP2016/063687

§ 371 Date: Nov. 16, 2017

(30) Foreign Application Priority Data
Jun. 18, 2015 (DE) 10 2015 007 696.5

(51) Int. Cl. H02M 1/14; H02M 3/157; H02M 1/32; H02M 3/158

(52) U.S. Cl. CPC H02M 1/14; H02M 3/158; H02M 1/32; H02M 3/157

(57) ABSTRACT

A voltage source for modulated DC voltages, operative to amplify the power of a reference signal to keep an output voltage constant, has a static DC voltage source with at least one parallel capacitor. The voltage source includes a first switching element, which is connected in parallel to the static DC voltage source and can be switched on or off by an unregulated controller; a second electronic switching element, which is connected in series to the first electronic switching element and in parallel to the DC voltage source and can be switched on or off by the controller; a coil, which is connected in series with the first electronic switching element and in parallel to the second electronic switching element; a smoothing capacitor, which is connected in series with the coil; and a load, which is connected in parallel to the smoothing capacitor.

### BACKGROUND OF THE INVENTION

The invention relates to a voltage source for modulated DC voltages for amplifying the power of a reference signal to keep an output voltage constant.

Modulated DC voltage sources for amplifying a reference signal with a broad frequency band (approximately 1 to 100 kHz) are typically implemented using an amplifier when power between a few kW up to the mid two-digit power range is needed. The amplifier is connected to a constant voltage source.

Standard constant voltage sources are usually equipped with large capacitors at the output. For example, according to the prior art, a switched-mode power supply for an output voltage of 50 V and a power of 3 kW has output capacitors with a total value of 5000 μF. For a voltage modulation of such a source, the capacitive reactive current would be many times greater than the load current, so that a modulation of the output voltage—even at low frequencies—would be virtually impossible.

Attempts have also been made to create highly efficient voltage sources with switched-mode power supplies optimized for dynamics. In such switched-mode power supplies, a smoothing circuit consisting of coil and capacitor often has a resonance frequency which, depending on the power and technology used, is only one-fiftieth to one-two-hundredth of the switching frequency. In practical applications, it has been shown that—due to the latency times resulting from internal processing—it is not possible to realize controlled systems with good linearity without natural oscillations over the entire required dynamic range and load range with reasonable effort while maintaining economic aspects.

The poor efficiency of these switched-mode power supplies is also due to the regulation used. The regulation results in large latency times that lead to oscillations. In this case, a large amount of energy is not converted into power, but converted into unneeded heat. This heat, in turn, must be dissipated and destroyed, which, in turn, has a negative effect on the efficiency.

### SUMMARY OF THE INVENTION

The principal objective of the present invention is to provide a voltage source for modulated DC voltages which achieves a high cost-effectiveness and a high degree of efficiency.

This objective, as well as other objectives which will become apparent from the discussion that follows, is achieved, in accordance with the present invention, by providing a static DC voltage source having at least one parallel capacitor and means for regulating the output of the DC voltage source.

A very low ohmic resistance and thus little loss can be achieved by using a type of voltage regulation for the DC voltage source that keeps the output voltage of the DC voltage source constant. This is achieved by providing a first switching element, which is connected in parallel to the static DC voltage source and can be switched on or off by an unregulated controller; a second electronic switching element, which is connected in series to the first electronic switching element and in parallel to the DC voltage source and can be switched on or off by the controller; a coil, which is connected in series with the first electronic switching element and in parallel to the second electronic switching element; a smoothing capacitor, which is connected in series with the coil; and a load, which is connected in parallel to the smoothing capacitor.

It is important to note that the first and the second electronic switching elements are not controlled linearly by the controller. Actual switching elements are coupled to the controller, which can be only in the on or off state. During operation of the device, basically only one of the two electronic switching elements is in the on-state, while the other is in the off-state.

When using respective modern components, the circuit reacts almost like an ideal system. As a result, no closed loop circuit is necessary and for the first time an unregulated controller is sufficient. A regulation is provided only for the static DC voltage source, so that a very exact DC voltage is always available. Such regulated DC sources are common today and do not require much effort. The lack of modulation control and the lack of associated feedback to the controller minimizes phase shifts and distortions and avoids further losses, so that the circuit operates with very high efficiency and can therefore be made very small. Consequently, a relatively simple controller can be used that does not require high cost.

The invention can be used successfully in a required power range between 1 and 50 kW. The modulated DC voltage is advantageously in a range of 1 to 200 kHz. Consequently, the modulated DC voltage may have been modulated at a high but also at a very low frequency. It may even contain sections resulting in a non-modulated, static voltage level. However, the two electronic switching elements are operated in particular with a switching frequency between 150 and 800 kHz. Below, this frequency will be referred to simply as the switching frequency.

The first and the second switching element should have the lowest possible resistance in the switched state. This is the only way to achieve a nearly ideal behavior of the circuit with very low power loss. For this reason, both the first electronic switching element and the second electronic switching element are each designed as a field effect transistor (FET). Modern FETs have this characteristic with a resistance of only a few milliohms and are therefore ideally suited for this application. If in case of high currents, the resistance of the FETs is still too great for an ideal behavior of the circuit, instead of one FET several of these components can be connected in parallel.

However, to obtain a modulated DC signal, the FETs are not driven as in an analog output stage, in which they are operated in linear operation, similar to a controlled resistor. In contrast, the first and second electronic switching elements are completely switched on or off opposite in phase. This means that at any time during the operation of the circuit, one of the electronic switching elements is switched and there is virtually no voltage drop between the terminals, while the other electronic switching element is at a high-resistance off-state, There are no intermediate states, so that the current always flows through either one or the other electronic switching element, but never through both at the same time.

The two electronic switching elements are switched via an unregulated controller. If the unregulated controller is designed as a digital controller, it has at least one analog-to-digital converter. In this case, an analog reference signal supplied to the controller is converted into digital data packets, which are forwarded to a digital controller. The digital controller generates the switching signals for controlling the two electronic switching elements from the digital data.

Depending on the quality of the regulation of the DC voltage source, the DC voltage may have a more or less large residual ripple. This residual ripple of the voltage signal can easily be corrected with the digital controller. The digital controller has for this purpose particularly advantageously an additional analog-to-digital converter, which is connected to the regulated DC voltage source and to the digital controller. In this way, it is not necessary to make high demands on the regulation of the DC voltage source and it is still possible to achieve an outstanding result.

The unregulated controller can also be set up as analog controller. A comparator is provided in the analog controller, which is also supplied with the analog reference signal. Furthermore, the signal of a sawtooth signal generator is applied to the comparator. The frequency of the sawtooth signal corresponds to the switching frequency of the two electronic switching elements. The control signals for controlling the two electronic switching elements are generated by comparing the two applied signals.

Should the controller fail or the alternating switching of the two electronic switching elements be stopped suddenly for another reason and both have a high resistance at the same time, for example, through an over-current protection circuit, voltage spikes may occur which can cause damage or even destruction of the circuit or of individual components. To prevent this, a “flyback,” protective diode is connected in parallel to the first and to the second electronic switching element. These protective diodes can be used to dissipate energy stored in the respective circuit. However, the protective diodes can be omitted if respective parasitic diodes are already installed in the electronic switching elements.

A similar problem may arise when the load applied to the output terminals of the circuit is suddenly dropped. In this case, a first voltage-limiting diode is connected in series with the coil and switched in parallel to the first electronic switching element or the first voltage-limiting diode and a second voltage-limiting diode are switched in parallel to the second electronic switching element. In the case described above, the energy stored in the coil can be fed back to the DC voltage source via the voltage limiting diode. In this way, this energy cannot cause overvoltage damage, but it is not lost to the system either.

To obtain a modulated DC signal with a small ripple that can be smoothed using capacitors having a low capacitance, the switching frequency that is used to operate the two electronic switching elements should not drop below a certain minimum frequency. The unregulated controller therefore switches the first and the second electronic switching element with a frequency greater than 150 kHz, but in particular greater than 200 kHz.

The minimum switching frequency depends inter alia on the maximum modulation frequency of the DC voltage. Thus, the modulated DC voltage may have a frequency up to 200 kHz if the switching frequency is set correspondingly high.

To reduce harmonics on the modulated DC signal, it is particularly advantageous to provide a filter circuit having a resonance coil and a resonance capacitor, wherein the filter circuit is arranged parallel to the smoothing capacitor. The filter circuit is tuned to the switching frequency of the electronic switching elements and thus ensures minimization of the capacitive load of the system, since the smoothing capacitor can be made very small in this way.

To operate the circuit according to the invention with low phase shifts and distortions, the coordination between the coil and the smoothing capacitor plays a significant role. Particularly advantageous is the coordination when the coil and the smoothing capacitor are tuned to a resonance frequency that is between one third and one fifteenth of the frequency that is used to switch the first and the second electronic switching element. For example, at a switching frequency of 300 kHz, the resonance frequency of the coil and the smoothing capacitor should consequently be between 20 and 100 kHz. In particular, it should be between one-sixth and one-twelfth of the switching frequency, in the above example, thus between about 25 and 50 kHz. This can ensure that the circuit is very low in resonance and loaded with the smallest possible capacitive reactive currents and thereby works with only very small losses.

Particularly advantageous, a high-frequency amplifier as a load is provided, which is additionally supplied with a high-frequency signal from an oscillator. In this way, one obtains an amplitude-modulated high-frequency signal, which was generated from the original reference signal. The system responds very dynamically to changes in the frequency of the reference signal and works with extremely low losses and with high cost efficiency.

The voltage source is designed as a switched-mode power supply with an output power of more than one kilowatt. In particular, switched-mode power supplies with a power between one and fifty kilowatts can be realized in this way with low costs and very low losses. When using a regulated DC voltage source, it is readily possible in the stated power range to dispense with a regulation that controls the electronic switching elements using a complex control loop.

For a full understanding of the present invention, reference should now be made to the following detailed description of the preferred embodiments of the invention as illustrated in the accompanying drawings.

### BRIEF DESCRIPTION OF THE DRAWINGS

FIG. 1 depicts the circuit of a voltage source according to the invention.

FIG. 2 depicts the controller of the voltage source of FIG. 1, designed as an analog controller.

FIG. 3 depicts the controller of the voltage source of FIG. 1, designed as a digital controller.

FIG. 4 depicts the voltage source of FIG. 1 according to the invention in connection with a high-frequency amplifier.

FIG. 5 shows a modulation signal amplified and smoothed by the modulator as the supply voltage for the high-frequency amplifier.

FIG. 6 shows the high-frequency sine signal of a high-frequency oscillator as the carrier frequency for the high-frequency amplifier.

FIG. 7 shows the high-frequency signal, modulated by the modulation signal and present at the output of the high-frequency amplifier.

### DESCRIPTION OF THE PREFERRED EMBODIMENTS

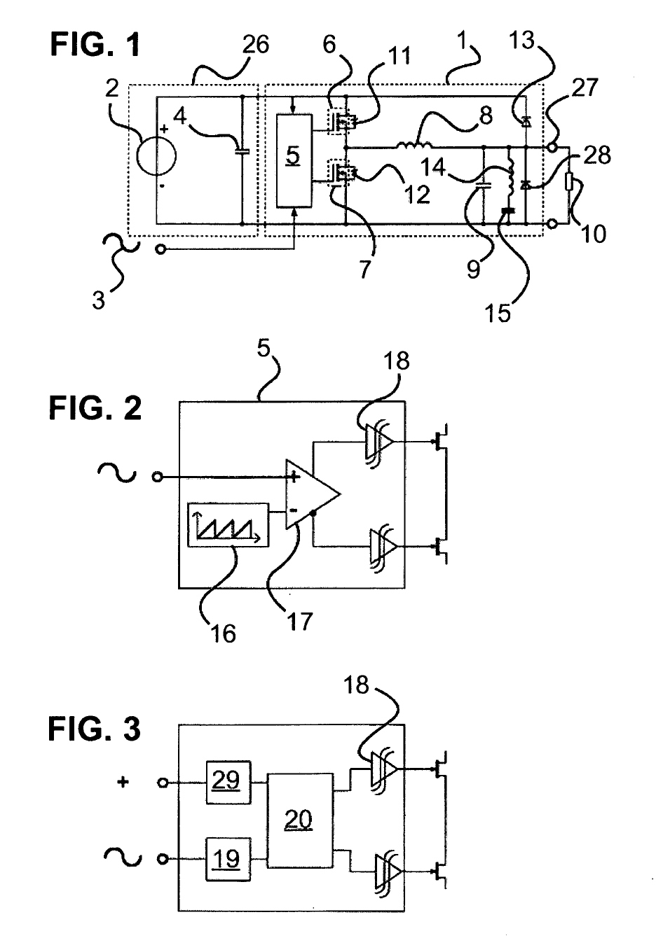

The preferred embodiments of the present invention will now be described with reference to FIGS. 1-7 of the drawings. Identical elements in the figures are designated with the same reference numerals.

The reference sign 3 designates the reference signal. This highly dynamically modulated reference signal is to be power-amplified, but remain as unchanged as possible in shape and phase. The reference signal 3 is applied to the controller 5 of the modulator 1.

The power supply 26 is of a standard design and consists of the static DC voltage source 2 that can handle a great power and the capacitor 4. The capacitor 4 is drawn representative of several capacities, which can absorb occurring voltage peaks and thus protect the DC voltage source 2 against damage. The DC voltage source is a regulated DC voltage source, i.e., a so-called constant-voltage source, which provides a very exact voltage.

The modulator 1 has a controller 5. Alternative embodiments of the controller are shown in FIGS. 2 and 3. The reference signal 3 is supplied to the controller 5 in both cases. In the analog controller of FIG. 2, the reference signal 3 is connected to the positive input of a comparator 17. The negative input is connected to a sawtooth signal generator 16. The comparator 17 has a conventional output and an inverted output. Both outputs are each connected to a galvanically isolated driver circuit 18 for the electronic switching elements 6 and 7, which provide the necessary signals for optimal on/off control of the electronic switching elements 6 and 7. The comparator 17 compares the voltage amplitude of the reference signal 3 to the amplitude of the signal of the sawtooth generator 16 and switches according to the result either to one or the other output. The inverted output ensures that only one of the outputs is energized. The switching frequency of the electronic switching elements 6 and 7 corresponds to that of the sawtooth generator 16.

The digital controller of FIG. 3 has a first analog-to-digital converter 19 (ADC for short) to which the reference signal 3 is supplied and which generates digital data packets and transfers them to the digital controller 20. With ADC 19 as the sole ADC, the digital controller 20 switches the FETs 6 and 7 based on the relationship

Uₐ=Uᵢₙ*vₜ,

where Uₐ is the output voltage applied to terminals 27, Uᵢₙ is the input voltage of the reference signal 3 and vₜ is the duly ratio. The duty ratio is the relative on-time of the electronic switching elements 6 and 7. The duty ratio and thus the switching frequency of the electronic switching elements 6 and 7 is determined by a frequency generator in the controller 20. The two switches are inverted as in the analog controller.

Another ADC 29, which is connected to the DC voltage source 2 (see the dashed arrow in FIG. 1) and also to the digital controller 20 is provided in the particularly advantageous embodiment of FIG. 3. The digitized voltage of the regulated DC voltage source is included as a variable Uₒ in the calculation of the digital controller 20.

The respective modified equation is then

Uₐ=Uᵢₙ*Uₒ*vₜ.

As a consequence, the compensation of the residual ripple of a not optimally regulated DC voltage source is also possible in this way via an unregulated controller without having to accept the disadvantages of a control loop. Since this can save costs in the regulated DC voltage source 2, this solution is very cost-effective, with few losses and nonetheless very accurate operation.

From the controller 5, the two electronic switching elements 6 and 7, which are designed in particular as FETs, are driven alternately. Modern electronic components of this type have a volume resistance in the single-digit milliohm range when switched on. With high currents, several of these FETs can be switched in parallel, so that the volume resistance can be reduced further in this way.

The two electronic switching elements 6 and 7 are driven in phase opposition. In operation, one of the two electronic switching elements is always conductive. A duty ratio of 1 exists when the first electronic switching element 6 is permanently in the on-state. On the other hand, a duty ratio of 0 exists when the first electronic switching element 6 is permanently in the off-state.

This circuit is not designed as an analog power amplifier, in which the electronic switching elements are operated in linear operation, similar to a controlled resistor. In the circuit shown here, one of the two electronic switching elements 6 and 7 is always fully conductive, i.e., controlled such that it reaches its minimum on-resistance, while at the same moment the other electronic switching element has a high resistance, i.e., no current is present.

The two protective diodes 11 and 12 are each connected in parallel to the two electronic switching elements. These protective diodes have no function during normal operation, but are required, for example, by a sudden shutdown of the electronic switching elements caused by an overcurrent to dissipate the energy stored in the coil 8. For the sake of simplicity, the circuit implementation for such a sudden shutdown is not presented in detail in the exemplary embodiment shown. In the usual way, however, a protective shutdown takes place via direct intervention in the drivers of the FETs 6 and 7, in the exemplary embodiment shown in the driver circuits 18 using galvanic isolation.

The coil 8 together with the two electronic switching elements 6 and 7 forms the core of the modulator 1. To achieve the lowest possible phase shift between the voltage of the reference signal supplied to the controller 5 and the output voltage present at terminals 27 of the modulator, the coil 8 is designed as a very small inductance. On the other hand, a minimum size of the inductance must be given in order to ensure the necessary filtering effect. In the exemplary embodiment shown here, a coil with an inductance of 3 μH is used.

The smoothing capacitor 9 has the task of reducing the ripple created by the switching frequency of the controller 5 in the output voltage present at terminals 27, the modulation signal. Nevertheless, the smoothing capacitor 9 should be kept as small as possible in order to minimize the reactive currents during the modulation. In the exemplary embodiment shown, a ceramic capacitor with a capacitance of 6 μF is used.

The filter circuit of the resonance coil 14 and the resonance capacitor 15 is coordinated such that its resonance frequency corresponds to the switching frequency of the controller 5. The filter circuit has a very low resistance at the resonance frequency and in this way, short-circuits the components of the switching frequency against the negative pole of the DC voltage source. This allows for the elimination of resonance components. The filter circuit thus acts as an optimal filter. The smoothing capacitor 9 loading the system with reactive current can be dimensioned very small in this way. In the exemplary embodiment shown, a capacitance of 2 μF is used for the resonance capacitor 15 and an inductance of 0.14 μH for the resonance coil 14.

The shown smoothing capacitor 9 represents the accumulated value of the effective capacitors used in the circuit. The term effective capacitors here refers to the fact that they are effective even at high currents and thus have a correspondingly low serial equivalent resistance. In order not to overload the circuit with reactive currents during modulation in the modulator 1 shown here, the sum of the capacitors used in the voltage path, all of which act as smoothing capacitors, must be as small as possible. The few remaining capacitors are exposed to high current loads and should therefore be designed expediently as ceramic capacitors. These capacitors in the capacitance range of 0.1 to about 1 μF have a very low equivalent series resistance and are therefore very effective in their role as filter capacitors despite their small capacitance.

The voltage limiting diodes 13 and 28 do not perform any function during normal operation of the circuit. In the case of a sudden load drop, however, they can prevent damage of the load 10 through occurring overvoltages. In this case, the energy stored in the coil 9 can be fed back to the capacitor 4 via the voltage limiting diode 13. The second voltage limiting diode 28 is provided and dissipates the energy to the negative pole of the DC voltage source in order to ensure this protection even when the sudden load drop occurs at the time of the current feedback (negative flank of the voltage curve).

For a similar case, the first 11 and the second protective diode 12 are provided, which are connected in parallel to the first 6 and to the second electronic switching element 7, respectively. If the switching stage with the controller 5 and the two electronic switching elements 6 and 7 are suddenly turned off, the energy is dissipated from the coil 8 via these protective diodes 11 and 12. This task could possibly also be assumed by parasitic diodes that are directly installed in the electronic switching elements 6 and 7. The separate protective diodes 11 and 12 could be omitted in this case.

Amplitude-modulated high-frequency signals are usually generated using power amplifiers that are supplied by a constant DC voltage source. The power amplifiers are amplitude-modulated via a composite reference signal that combines carrier frequency and amplitude modulation. Such power amplifiers with a large dynamic range, which can be used in the high-frequency range, are generally designed as linear amplifiers. However, these amplifiers have a poor efficiency, especially in the partial load range, i.e., in the central range of the modulation amplitude.

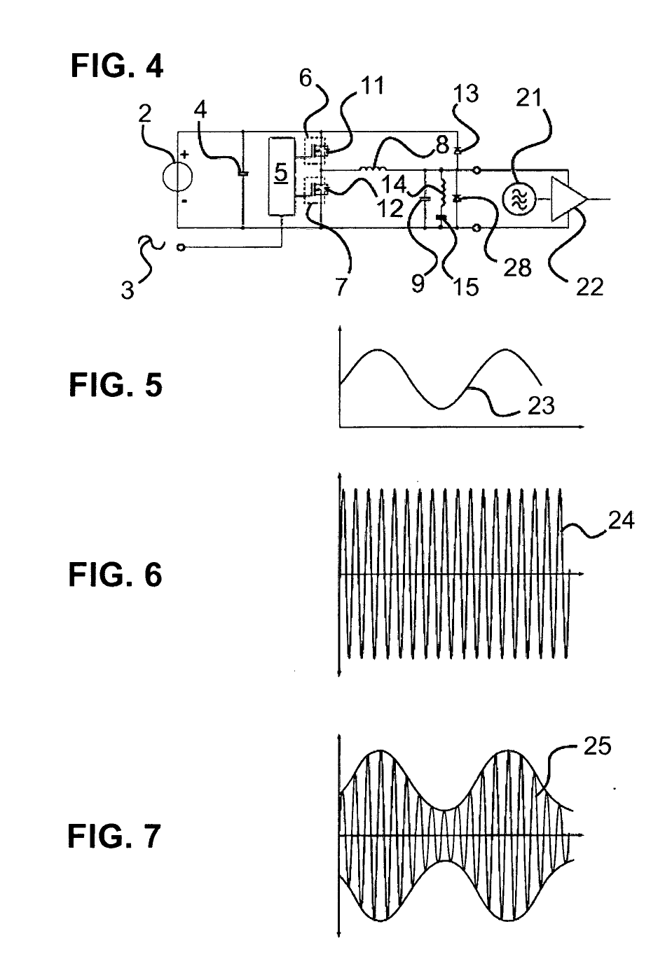

FIG. 4 shows an application of the invention, with can be used to generate such an amplitude-modulated high-frequency signal with high efficiency. The load 10 shown in FIG. 1 is formed by the high-frequency amplifier 22. A respective circuit can be used, for example, as a power supply for a plasma generator. Especially in the ignition phase of the plasma, highly dynamic high-frequency generator systems are required for these applications in order to prevent the final stage from being destroyed in the event of mismatch and feed back transmission power.

The high-frequency amplifier 22 is supplied with the smoothed modulation signal 23 shown in FIG. 5 as a supply voltage, which is present at terminals 27 of the modulator 1. Simultaneously, the high-frequency signal 24 shown in FIG. 6 of a high-frequency oscillator 21 is supplied as a carrier signal to the high-frequency amplifier 22. The supply voltage and the carrier signal then result at the output of the high-frequency amplifier 22 in the modulated high-frequency signal 25, shown in FIG. 7, which is an amplitude-amplified signal, wherein the modulation signal 23 has been modulated onto the high-frequency carrier signal 24 of the high-frequency oscillator 21.

In the signal representation in FIGS. 5 and 7, it has been assumed that the modulation signal 23 is a sinusoidal signal. Of course—depending on the application—any other signal shape, even with static areas, is possible. In contrast, the high-frequency signal 24 is always a sinusoidal signal.

In the exemplary embodiment of FIG. 1, the controller 5 of the modulator 1 is supplied with a sinusoidal reference signal 3 with a fast-changing frequency, for example. The modulation frequency of the reference signal 3 is in this example up to 10 kHz. This reference signal has a voltage amplitude of 5 V, for example.

The modulator 1 is connected to a static DC voltage source 2, which supplies a voltage of 50 V and a maximum current of 100 A. The DC voltage source 2 can therefore be loaded with a maximum power of 5 kW.

The controller 5 switches the two FETs 6 and 7 in the manner already explained above using a switching frequency of 300 kHz. With a modulation amplitude of 100%, this results in a modulation signal whose frequency corresponds to the frequency of the reference signal 3, however, with a voltage having an amplitude of 50 V at a maximum power of 5 kW. The modulated DC voltage signal has a certain ripple corresponding to the switching frequency of 300 kHz. Consequently, a sinusoidal voltage with a higher-frequency harmonic arises. This ripple can be smoothed by appropriate design of the capacitances to the extent that with the modulation signal present at terminals 27, the harmonic only has a slight remaining ripple. This harmonic becomes smaller the more the switching frequency differs from the modulation frequency.

Due to the special structure of the circuit, the phase of the modulation signal differs only very slightly from the phase of the reference signal 3. Due to the small capacitances and inductances used and the exact coordination of the filter circuit with the resonance capacitor 15 and the resonance coil 14, only very small reactive currents are generated during the modulation and the modulation takes place with a very high efficiency. A modulation signal with the same frequency and very low phase shift, but with a larger amplitude and higher power arises thus from the supplied reference signal 3 through the circuit according to the invention.

The exemplary embodiment shown in FIG. 1 can also be designed with suitable components such that a reference signal can be processed up to the 100 kHz range and higher. When using a respective static DC voltage source, wattages up to the middle double-digit kW range are possible. The circuit according to the invention works completely without a closed loop since it behaves almost like an ideal system. In particular, the modern electronic switching elements 6 and 7, which have an extremely low on-resistance of only a few milliohms, contribute to this behavior, if higher currents are required, these components are relatively easy to connect in parallel and the on-resistance can thus be further minimized. Thus, no internal voltage drops caused by load changes need to be compensated because there are hardly any internal resistances that would be responsible for a respective voltage drop. The function of the output voltage is thus easy to define and can be simulated using an analog or digital controller without closed loop.

A very high system efficiency of the arrangement shown in FIG. 4 can be achieved by always fully modulating the high-frequency amplifier 22 with the high-frequency oscillator 21. The analog high-frequency amplifier 22 has its highest efficiency at full modulation. The amplitude or power modulation of the system takes place only with the change of the modulation signal 23, i.e., the supply voltage of the high-frequency amplifier 22. The very high system efficiency is a result of the modulator 1, which generates the modulation signal 23 and thus the supply voltage for the high-frequency amplifier 22, having a very high efficiency, high dynamics and good linearity.

There has thus been shown and described a novel voltage source for modulated DC voltages which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. In a voltage source for modulated DC voltages for amplifying the power of a reference signal having a static DC voltage source with at least one parallel capacitor, the improvement comprising voltage regulation means for regulating the output voltage of the DC voltage source; a first electronic switching element, which is connected in parallel to the DC voltage source and can be switched on or off by an unregulated controller; a second electronic switching element, which is connected in series to the first electronic switching element and in parallel to the DC voltage source and can be switched on or off by the controller; a coil, which is connected in series to the first electronic switching element and in parallel to the second electronic switching element; a smoothing capacitor, which is connected in series to the coil; and a load, which is connected in parallel to the smoothing capacitor.

2. Voltage source as in claim 1, wherein both the first electronic switching element and the second electronic switching element are designed as field effect transistors.

3. Voltage source as in claim 1, wherein the first and the second electronic switching element are connected in phase opposition.

4. Voltage source as in claim 1, wherein the unregulated controller comprises at least one analog-to-digital converter and one digital controller.

5. Voltage source as in claim 4, wherein the digital controller has another analog-to-digital converter that is connected to the regulated DC voltage source and to the digital controller.

6. Voltage source as in claim 1, wherein the unregulated controller comprises an analog controller and a comparator.

7. Voltage source as in claim 1, wherein a flyback diode is switched parallel to each of the first and the second electronic switching element.

8. Voltage source as in claim 1, wherein a first voltage-limiting diode is connected in series with the coil and switched in parallel to the first electronic switching element.

9. Voltage source as in claim 1, wherein the unregulated controller switches the first and the second electronic switching element with a frequency greater than 200 kHz.

10. Voltage source as in claim 1, wherein the modulated DC voltage has a frequency of up to 200 kHz.

11. Voltage source as in claim 1, wherein a filtering circuit is provided with a resonance coil and a resonance capacitor, and wherein the filtering circuit is arranged parallel to the smoothing capacitor.

12. Voltage source as in claim 1, wherein the coil and the smoothing capacitor are coordinated to a resonance frequency that is between one third and one fifteenth of the frequency that switches the first and the second electronic switching element.

13. Voltage source as in claim 1, wherein a high-frequency amplifier is provided as the load, which is additionally supplied with a high-frequency signal from a high-frequency oscillator.

14. Voltage source as in claim 1, wherein the voltage source is a switched-mode power supply with an output wattage of more than one Kilowatt.

15. Voltage source as in claim 1, wherein a first voltage-limiting diode and a second voltage-limiting diode are switched in parallel to the second electronic switching element.
